(19) United States
(12) Patent Application Publication
(10) Pub. No.: US 2021/0331802 A1
(43) Pub. Date: Oct. 28, 2021

(54) Passenger Protection System for Aircraft

(71) Applicant: Thomas J. Shaw, Little Elm, TX (US)

(72) Inventor: Thomas J. Shaw, Little Elm, TX (US)

(21) Appl. No.: 17/236,907

(22) Filed: Apr. 21, 2021

Related U.S. Application Data
(60) Provisional application No. 63/013,762, filed on Apr. 22, 2020.

(51) Int. Cl. B64D 11/06; B64C 1/14; B64D 13/02

(52) U.S. Cl. CPC B64D 11/06; B64D 2011/0046; B64D 13/02; B64C 1/1423

(57) ABSTRACT

A passenger protection module for use inside an aircraft or other commercial carrier, the passenger protection module comprising an enclosure releasably installed inside an aircraft, at least one passenger seat installed inside the enclosure, a doorway providing passenger ingress into and egress from the enclosure, and a supply of treated and purified air flowing through the enclosure at a positive pressure relative to air outside the enclosure.

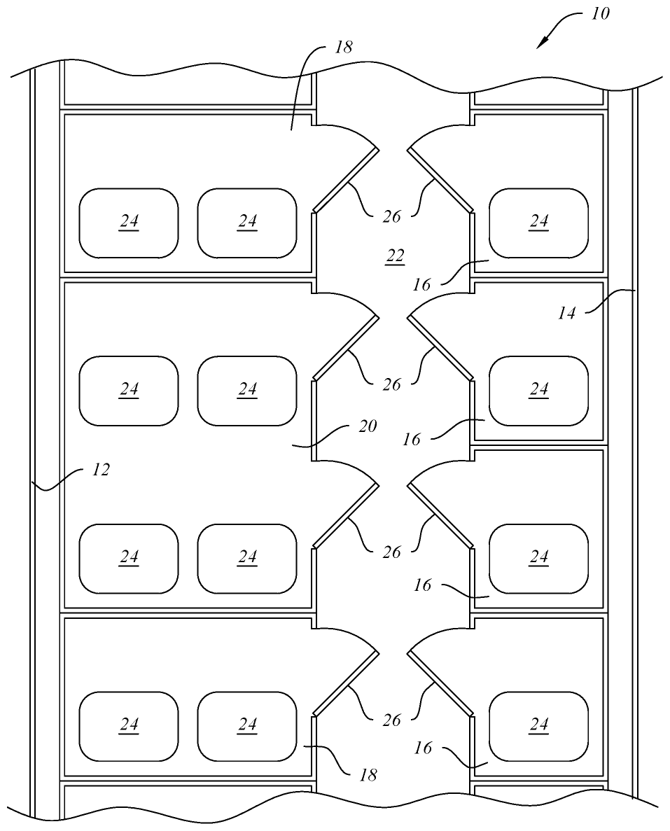

### 1. FIELD OF THE INVENTION

This invention relates primarily to passenger aircraft and relates more particularly to passenger aircraft configured to receive and support a plurality of releasably installed personal protection compartments or modules, with each being configured to protect one to two or more persons from infection or contamination by a harmful pathogen that might otherwise be transmitted to them during air travel. As used above, “support” means to provide stable and safe physical support to each compartment and to passengers seated within each compartment during travel, and to provide such ancillary utilities as are needed for the safety and comfort of each passenger during flights of the anticipated duration and route of travel. The subject invention also relates to the individual personal protection modules that are each configured to be releasably installed inside aircraft for the purpose of accommodating from one to two or more persons who are each seated individually in seats anchored inside the respective modules. The individual seats and the personal protection modules are desirably otherwise compliant with air transport regulations and standards applicable to air passenger travel, and configured and adapted to continuously provide fresh or recirculated filtered air to the interior of each compartment or module together with safe access to food, drink and such other utilities and amenities as may ordinarily be required or customarily provided on flights of the intended duration.

### 2. DESCRIPTION OF KNOWN RELATED ART

The corona virus (COVID-19) pandemic has demonstrated the need for new and better systems useful for transporting passengers by air. Although commercial airline passenger traffic has been greatly reduced during the pandemic, a need has remained throughout the crisis for moving people from one place to another by airplane under some circumstances. For example, cruise ships docking at ocean ports with hundreds of potentially infected passengers and crews have led to the use of chartered flights to relocate such persons to dedicated holding and quarantine facilities pending testing, treatment and eventual release. Also, despite “shelter in place” directives that have been widely used to keep employees at home and have led to the curtailment of operations in many “non-essential” businesses, urgent air transportation requirements continue to arise in connection with “essential” businesses and with production and distribution of medical products, medical equipment and human resources.

Many available sources, such as U.S. Pub. No. 2019/0366263 A1, disclose methods and apparatus for purification and treatment of air intended for use and consumption by humans.

### SUMMARY OF THE INVENTION

A passenger protection system comprising a plurality of travel compartments that are selectively installable inside passenger aircraft is disclosed. The system is especially intended to allow passengers to fly with significantly reduced risk of transmitting or acquiring a pathogenic infection during air travel. The subject system desirably comprises a plurality of passenger protection modules each configured to seat one or more passengers, preferably from one to four passengers in a single module releasably installed inside a passenger aircraft in accordance with standards required by the Federal Aviation Administration (FFA) or other applicable regulatory body, organization or authority. In one embodiment of the invention, each passenger module is totally self-contained, having its own front, back and side walls; a top wall; a bottom wall; a door and doorway allowing ingress into and egress from the module; and a shielded pass-through opening (disposed in the door or in an adjacent wall section) through which a flight attendant can serve food and/or beverages to the passengers during a flight. In this embodiment of the invention, the passenger seats can be pre-attached to the floor or walls of the module and the entire module can be bolted to the aircraft superstructure with available hook-ups provided as needed for providing and/or connecting to each module to an air purification system, a temperature control apparatus and emergency masks or oxygen as needed.

In another embodiment of the invention, each module of the subject system comprises a plurality of connectable partitions conforming to the existing top, bottom and side walls of the aircraft, with flexible sealing members provided between the connectable partitions and the aircraft walls. With this embodiment of the invention, the space inside the fuselage can be easily reconfigured to include passenger module of various sizes and existing seat anchors can be used to secure the properly positioned passenger seats in place prior to installing the individual partitions around them to form the desired module or modules. Attachment of wall panels to aircraft walls, bulkheads and overhead storage bins may also be helpful for providing structural integrity and stability for this embodiment. As with the embodiment discussed above, a doorway and a shielded pass-through are desirably provided for us in food and beverage service by flight attendants to passengers.

Doors suitable for use in the invention can be conventional hinged doors that swing horizontally into an aisle of the aircraft, or can be sliding doors that open in a direction substantially parallel to the doorway, or can be made with hinged panels connected and mounted on tracks that allow opening and closing vertically similarly to conventional doors used for other purposes such as garages, commercial storage compartments, truck cargo storage areas, and the like.

Conventional overhead storage commonly used in aircraft can be maintained in place for use by passengers as needed in addition to the under-seat storage provided inside each passenger module. Alternatively, in place of conventional overhead storage bins, especially configured storage bins can be provided within each passenger module.

With any of the foregoing embodiments of the invention, a positive air pressure is desirably maintained inside each module during boarding, flight or deplaning to reduce the likelihood that air contaminated with a pathogen can enter a module during flight—even when food or beverage service is being performed by flight attendants inside the passenger cabin(s) of the aircraft. To assist in preventing contamination of the environment inside each module while serving passengers during flights, suitable pass-through apparatus such as curtains, sliding panels, double-door compartments or containers, or other similarly effective apparatus or devices can be provided.

Normal or specially modified social distancing guidelines and mask requirements consistent with any applicable governmental, regulatory or airline policies or directives will presumably be enforced during preflight screening, pre-boarding, boarding and disembarkation. Use of restroom facilities during flights can also be controlled to incorporate protections provided by desirable social distancing, use of masks, and implementation of robust sanitization procedures between users.

Air treatment and purification can be handled by the installation of units inside each module, but is preferably achieved through use of one or more passenger-air pretreatment systems capable of servicing a plurality of the subject modules using flow lines and connectors that are appropriately configured and constructed for the intended service. As used in this disclosure, “air treatment and purification” is intended to encompass filtration, ultrafiltration, ultraviolet sterilization, temperature and humidity control, chemical treatment and the like that are appropriate to the intended service.

In another embodiment of the invention, a passenger protection module is disclosed for use in a selectively releasable enclosure installed inside an aircraft or other commercial carrier such as a boat, train or bus, the passenger protection module comprising at least one passenger seat installed inside the enclosure, a doorway providing passenger ingress into and egress from the enclosure, and a supply of treated and purified air maintained inside or circulated through the enclosure at a positive pressure relative to air outside the enclosure.

These and other features, objects and advantages of the present invention will become better understood from a consideration of the following detailed description of a preferred embodiments and appended claims in conjunction with the drawings.

### BRIEF DESCRIPTION OF THE DRAWING

The system and method of the invention are further described and explained in relation to the following drawing, which is a diagrammatic top plan view intended to be representative of a fuselage or body section of a passenger aircraft or other commercial carrier depicting in simplified diagrammatic form one embodiment of an array comprising a plurality of selectively attachable and releasable passenger modules of different sizes as installed inside the fuselage, with each passenger module having from one to four passenger seats installed inside and also comprising means providing convenient ingress into and egress from each passenger module.

### DESCRIPTION OF A PREFERRED EMBODIMENT

Referring to the accompanying drawing FIGURE, a body section of a conveyance device as operated by a commercial carrier is depicted in simplified form. More particularly, aircraft fuselage section 10 is depicted in an embodiment where fuselage side walls 12, 14 contain a plurality of passenger modules 16, 18, 20 each having from one to four passenger seats 24 installed inside the module. In the embodiment shown, a row of single-seat passenger modules 16 is provided on one side of aisle 22 and a row of interspersed two-passenger modules 18 and a four-passenger module 20 are provided on the opposite side of aisle 22. At least one door 26 is provided for each passenger module 16, 18, 20 and in the embodiment shown, passenger module 20 has two doors to facilitate direct access to each of the two rows of seat 24 provided in that module.

As mentioned in the invention summary above, each passenger module can be provided with a shielded pass-through to facilitate food and beverage service by a flight attendant. As installed inside an aircraft or other commercial carrier, each passenger module desirably also comprises at least one air inlet port, at least one air outlet port (not shown for drawing simplification) that are operatively connected to a filtered air treatment and purification system that is configured to maintain a positive pressure inside each passenger module 16, 18, 20 when doors 26 are closed. Maintaining positive pressure inside each passenger module 16, 18, 20 will reduce the likelihood of contaminated air containing harmful pathogens from entering each passenger module and will reduce the likelihood of the pathogens being transmitted to a passenger inside the module. Alternatively, each passenger module 16, 18, 20 can be constructed with a dedicated air treatment, purification and pressurization system, but the provision, installation and use of such dedicated systems will drive up the cost to airlines and potential users.

The selection, installation or adaptation of a particular air treatment and purification system for the uses disclosed herein are considered to be a matter within the capabilities of one of ordinary skill in the art who reads the specification in conjunction with the accompanying drawing and is knowledgeable regarding the many known, conventional, commercially available air treatment and pressurization systems. Those of ordinary skill in the art will also appreciate upon review and consideration of this specification and the accompanying drawing that various modifications and alterations to the subject apparatus can be made within the scope of the invention, and it is intended that the scope of the invention disclosed herein be limited only by the broadest interpretation of the appended claims to which the inventor is legally entitled.

What is claimed is:

1. A passenger protection system comprising a plurality of selectively moveable and relocatable passenger modules each configured to seat one or more passengers in a contained, positive-pressure environment during flight of an aircraft.

2. The passenger protection system of claim 1 wherein each passenger module is configured to seat from one to four passengers.

3. The passenger protection system of claim 1 wherein each passenger module further comprises a door and a doorway allowing passenger ingress into and egress from the module.

4. The passenger protection system of claim 1 wherein each passenger module comprises means to facilitate food and beverage service to each passenger inside the passenger module.

5. The passenger protection system of claim 1 wherein each passenger module operably communicates with a continuous source of filtered, treated and pressurized air.

6. The passenger protection system of claim 1 wherein each passenger module is releasably attached to the aircraft.

7. The passenger protection system of claim 7 wherein each passenger module comprises at least one passenger seat releasably attached directly to the aircraft.

8. The passenger protection system of claim 7 wherein each passenger module comprises at least one passenger seat that is releasably attachable to the passenger module.

9. The passenger protection system of claim 1 wherein each passenger module comprises a plurality of wall sections.

10. The passenger protection system of claim 5 wherein each passenger module is configured to continually receive and discharge a supply of air sufficient to maintain a positive pressure inside each passenger module relative to the air pressure inside the aircraft but outside the passenger module.

11. A passenger protection module for use inside an aircraft, the passenger protection module comprising an enclosure releasably installed inside an aircraft, at least one passenger seat installed inside the enclosure, a doorway providing passenger ingress into and egress from the enclosure, and a supply of treated and purified air maintained inside the enclosure at a positive pressure relative to air outside the enclosure.

12. A passenger protection module for use inside an aircraft or other commercial carrier, the passenger protection module comprising an enclosure releasably installed inside an aircraft, at least one passenger seat installed inside the enclosure, a doorway providing passenger ingress into and egress from the enclosure, and a supply of treated and purified air flowing through the enclosure at a positive pressure relative to air outside the enclosure.
